(19) United States
(12) Patent Application Publication
(10) Pub. No.: US 2015/0078117 A1
(43) Pub. Date: Mar. 19, 2015

(54) DEVICE FOR DISPENSING A MIXTURE, PREFERABLY FOAM

(71) Applicant: TAPLAST S. P. A., Dueville-Povolaro (IT)

(72) Inventor: Evans Santagiuliana, Vicenza (IT)

(21) Appl. No.: 14/396,355

(22) PCT Filed: Apr. 17, 2013
(86) PCT No.: PCT/IB2013/000716

§ 371 Date: Oct. 22, 2014

(30) Foreign Application Priority Data
Apr. 26, 2012 (IT) VI2012A000100

(51) Int. Cl. B01F 3/04; B01F 15/02

(52) U.S. Cl. CPC B01F 3/04446; B01F 15/0256
USPC 366/181.6

(57) ABSTRACT

The present invention is a device (10; 110; 210; 310) for dispensing a mixture (S), suited to be applied to a container (C) holding a first fluid (F1) and a second fluid (F2) suited to be mixed in order to obtain a mixture (S), comprising: a first body (13); a second body (32) associated with the first body (13); a mixing chamber (12) defined at least partially in the first body (31) and/or in the second body (32); a first delivery duct (C1) suited to convey the first fluid (F1) towards the mixing chamber (12); a second delivery duct (C2) suited to convey the second fluid (F2) towards the mixing chamber (12); a thin tube (38) suited to define at least partially the first duct (C1) and comprising an end portion (39) connected to the first or the second body (31, 32). The end portion (39) of the thin tube (38) is connected to the first body (31) or the second body (32) so as to define for the first fluid (F1) a main advance direction (D1) that belongs to a longitudinal axis (X) that intersects the mixing chamber (12). The invention furthermore concerns a system (1) for dispensing a mixture (S).

### TECHNICAL FIELD OF THE INVENTION

The present invention concerns the field of systems for dispensing mixed fluids. In particular, the present invention refers to a device for dispensing a mixture of two fluids that can be applied to a container holding these fluids, particularly for dispensing a mixture in the form of foam.

### DESCRIPTION OF THE STATE OF THE ART

The use of dispensing devices is known in the sector of equipment for dispensing products in the form of foam, wherein said dispensing devices are applied to deformable containers, usually made of plastic, which when pressed manually allow the foam to be dispensed therethrough.

In such dispensing systems foam is produced by properly mixing a given quantity of liquid and air taken from said containers.

The fields of application of these types of foam production and dispensing systems are the most varied. In the sector of cleaning foams are produced for cleaning bathrooms, windows, kitchen ovens, furniture, or for distributing soap, shampoo or face cleansers. As far as personal hygiene and health products are concerned, foam products are used, for example, for hand care, hair care, skin care, shaving, or again as toiletries for animals like cats and dogs. Furthermore, there are specific applications in the medical sector, for example sunscreen foams or similar products.

The systems of the known type consist of a dispensing device applied to the neck of a container. In the dispensing device it is possible to identify a chamber which, during the manual deformation of the container, receives the liquid drawn from the container through a thin tube and the air contained in the container itself. The mixture of liquid and air that reaches this chamber flows out of the same and is changed into foam thanks to the presence of a filtering element provided with suitable micro holes that allow the mixture to flow out in the form of foam, also depending on the viscosity characteristics of the liquid and on the quantity of air mixed with said liquid. These systems can be used keeping the container in both the upright and the overturned position.

The dispensing devices applied to the containers substantially consist of a supporting structure provided with means for coupling with the container's neck and with a suction unit suited to draw the fluids from the inside of the container and to produce the foam that is successively dispensed.

The foam generated in this way is conveyed towards the external environment through a suitable outlet duct.

The correct formation of the foam in terms of correct percentage of fluid and air in the foam itself depends on the type of fluid, in particular on its higher or lower viscosity. For different types of fluid it will therefore be necessary to provide devices that are different from time to time and allow mixing to be carried out with the correct and desired air/fluid ratio.

The dispensing devices belonging to the state of the art however pose some drawbacks.

A first drawback posed by said dispensing devices is represented by the fact that they are difficult to manufacture and that it is necessary to provide a plurality of different devices, one for each type of fluid used in the mixture.

Another drawback posed by these devices lies in that their operation changes depending on whether the container is positioned upright or overturned.

A further drawback posed by the devices of the known type is constituted by the flow resistance to which the fluids are subjected along the respective channels that convey them to the mixing chamber when the container is deformed.

Another drawback posed by the devices of the known type is constituted by the fact that the mixing chamber is filled with the fluids to be mixed in a non-homogeneous manner. This is mainly due to the special shape assumed by the channels that convey the fluids towards the mixing chamber.

It is the object of the present invention to overcome the above mentioned drawbacks.

In particular, it is a first object of the invention to provide a device for dispensing mixtures that makes it possible to reduce production costs compared to the devices of the known type.

It is another object of the invention to provide a device for dispensing mixtures that can be adapted to the characteristics of the fluid of which the mixture is made.

It is a further object of the invention to provide a device for dispensing mixtures that can be configured in such a way as to obtain the best mixture, as desired, by replacing/modifying the smallest number of elements making up the device.

It is another object of the invention to provide a device that makes it possible to reduce the flow resistance of the fluids to be mixed during the dispensing operation.

It is another object of the invention to provide a device that makes it possible to improve the fluid mixing operation inside the mixing chamber.

### SUMMARY OF THE PRESENT INVENTION

According to a first aspect of the invention, therefore, the subject of the same is a device for dispensing mixtures, suited to be applied to a container that holds a first and a second fluid suited to be mixed together in order to obtain said mixture, said device comprising:
a first body;
a second body associated with said first body;
a mixing chamber defined at least partially in said first body and/or in said second body;
a first duct suited to convey said first fluid towards said mixing chamber;
a second duct suited to convey said second fluid towards said mixing chamber;
a thin tube suited to define at least partially said first duct and comprising an end portion connected to said first or to said second body,
   wherein said end portion of said thin tube is connected to said first body or to said second body in such a way as to define for said first fluid a main advance direction belonging to a longitudinal axis that intersects said mixing chamber.

Preferably, the end portion of the thin tube has a substantially cylindrical shape that extends along said longitudinal axis.

In a first preferred embodiment, the end portion of the thin tube is accommodated in a housing seat provided in the first body or in the second body, said housing seat extending along said longitudinal axis.

The housing seat preferably has a portion that is substantially cylindrical in shape.

Advantageously, the housing seat is positioned centrally with respect to the first body or the second body in which it is obtained.

The dispensing device that is the subject of the invention properly comprises valve means suited to allow the flow of the first fluid in the thin tube to be blocked.

The valve means are preferably arranged upstream of the mixing chamber with respect to the main advance direction of the first fluid.

According to a preferred embodiment, the first duct comprises at least one section suited to convey the first fluid and defined by at least two surfaces facing each other and respectively belonging to the first body and to the second body.

According to another embodiment, the second duct comprises at least one section suited to convey the second fluid and defined by at least two surfaces facing each other respectively belonging to the first body and to the second body.

Advantageously, the device comprises snap connection means between the first body and the second body.

Preferably, the first body or the second body comprises means for connection to the container.

The device preferably comprises further valve means suited to restore the presence of air inside the container once the mixture has been dispensed.

According to a preferred embodiment, the device comprises a filtering element associated with the mixing chamber for the formation of the mixture.

According to a preferred embodiment, the first fluid comprises a liquid or a cream and the second fluid comprises air.

According to another preferred embodiment, the first fluid comprises air and the second fluid comprises a liquid or a cream.

The mixture obtained by means of the dispensing device of the invention is preferably a foam.

Advantageously, the first body is provided with means for connection to the container.

According to a second aspect of the present invention, the subject of the same is a system for dispensing a mixture, comprising a container suited to hold two fluids to be mixed and a dispensing device associated with said container and suited to mix said fluids and dispense said mixture, wherein said dispensing device is of the type described above.

### BRIEF DESCRIPTION OF THE DRAWINGS

Further advantages, objects and characteristics of the present invention, as well as further embodiments of the same are defined in the claims and will be illustrated in the following description with reference to the attached drawings; in the drawings, corresponding or equivalent characteristics and/or component parts of the present invention are identified by the same reference numbers. In particular:

FIG. 1 shows a first embodiment of the dispensing device that is the subject of the invention applied to a container;

FIG. 2 shows a first longitudinal cross section view of the device of the invention shown in FIG. 1;

FIG. 3 shows an exploded view of FIG. 2;

FIG. 3A shows an axonometric view of a detail of FIG. 3;

FIG. 4 shows a second longitudinal cross section view along a different section plane of the device of the invention shown in FIG. 1;

FIG. 5 shows a partial view of a variant embodiment of the device of FIG. 1 in overturned position of use;

FIG. 6 shows a longitudinal cross section view of the device of the invention shown in FIG. 5;

FIG. 7 shows an exploded view of FIG. 6;

FIG. 8 shows a variant embodiment of FIG. 2;

FIG. 9 shows an exploded view of FIG. 8;

FIG. 9A shows a variant embodiment of FIG. 8;

FIG. 10 shows another variant embodiment of FIG. 6;

FIG. 11 shows an exploded view of FIG. 10.

### DETAILED DESCRIPTION OF THE PRESENT INVENTION

The examples of embodiment of the invention described below refer to devices for dispensing products in the form of a foam preferably resulting from the combination of a first fluid, typically in liquid form, with a second fluid, typically air, both present inside the container to which the device is applied.

It is clear that the proposed solution can be applied also to devices for dispensing foams where the composition of the two fluids can be different, as for example in the case in which the fluid used comes in the form of cream.

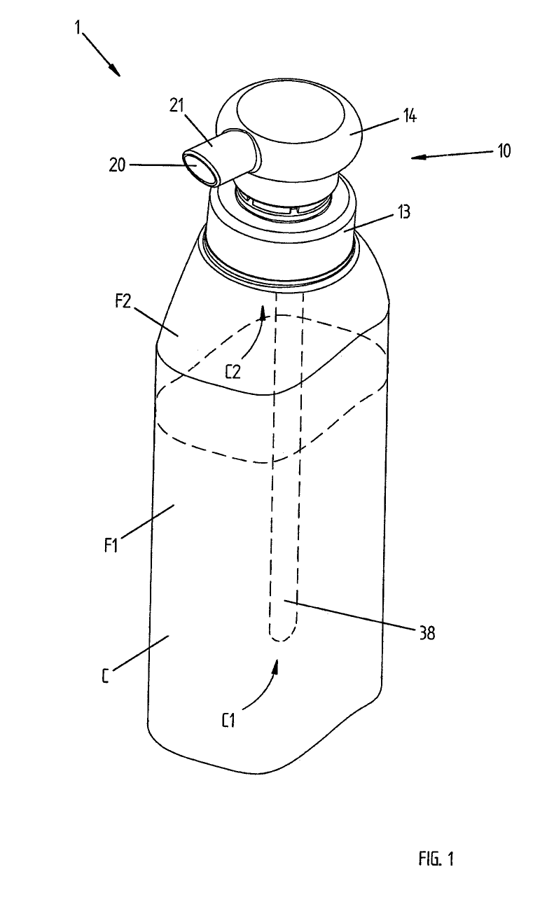

An example of embodiment of a system 1 for dispensing a mixture, denoted here below simply as a foam S, is shown in FIG. 1, in which a dispensing device according to the present invention, indicated as a whole by 10, is applied to a container C holding the fluids to be mixed.

It can be observed that the container C of the invention is preferably a bottle made of a material that can be easily deformed by the pressure exerted by the hand that is grasping it, and is preferably made of a plastic material.

It is evident that this deformation can be obtained in any other manner, for example with the aid of special mechanisms suited to deform the external surface of the container C.

Said container C is filled with a first fluid F1 up to a suitable level, shown with a broken line in FIG. 1, while the remaining space above said fluid F1 will contain air, suited to constitute the second fluid F2 making up the foam S to be obtained.

The dispensing device of the invention 10 is applied to the neck of said container C, a mixing chamber 12 being defined within said dispensing device 10, as is better explained below. The dispensing device 10 is provided with suitable ducts C1, C2 suited to convey the fluids F1, F2 to said mixing chamber 12, where the mixed fluids will form the foam S that can be dispensed through a suitable outlet duct 20 of a spout 21.

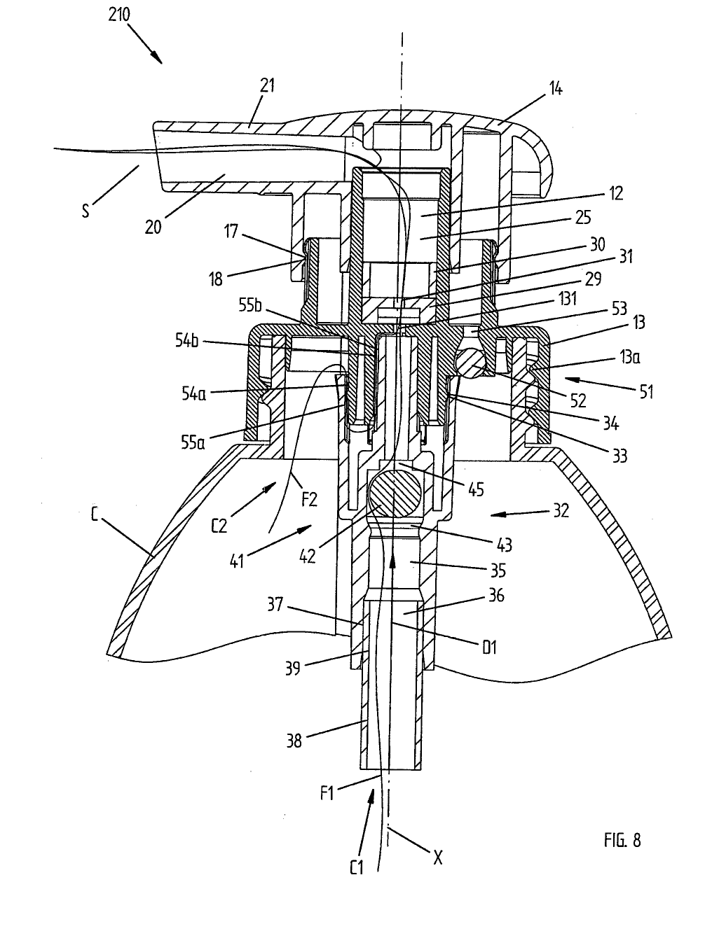

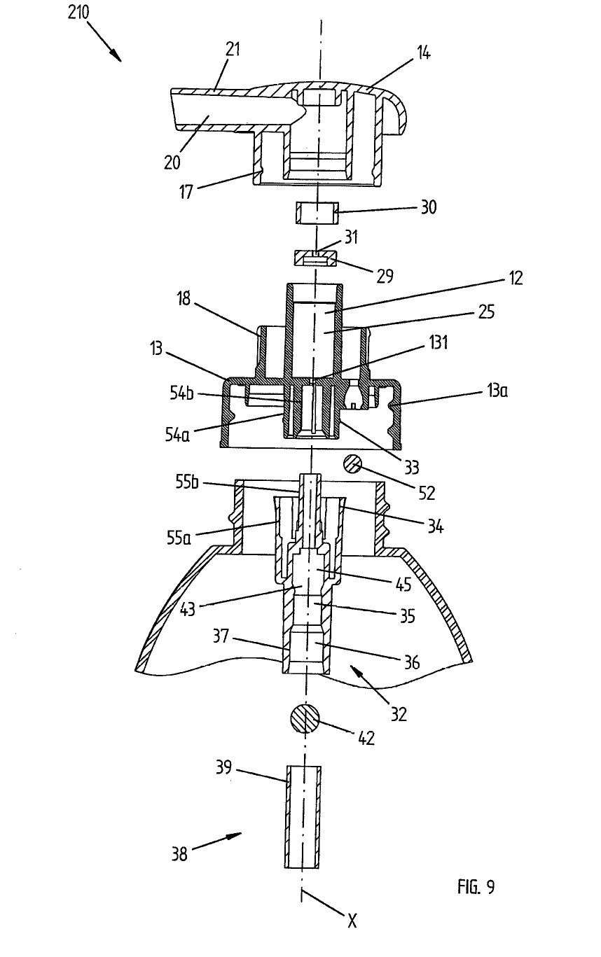

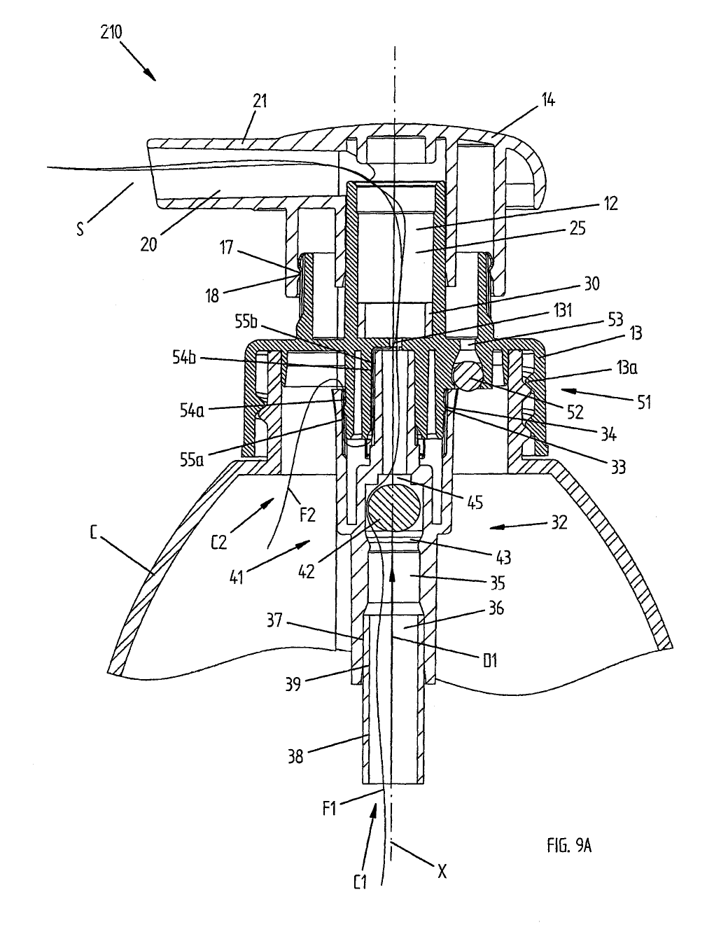

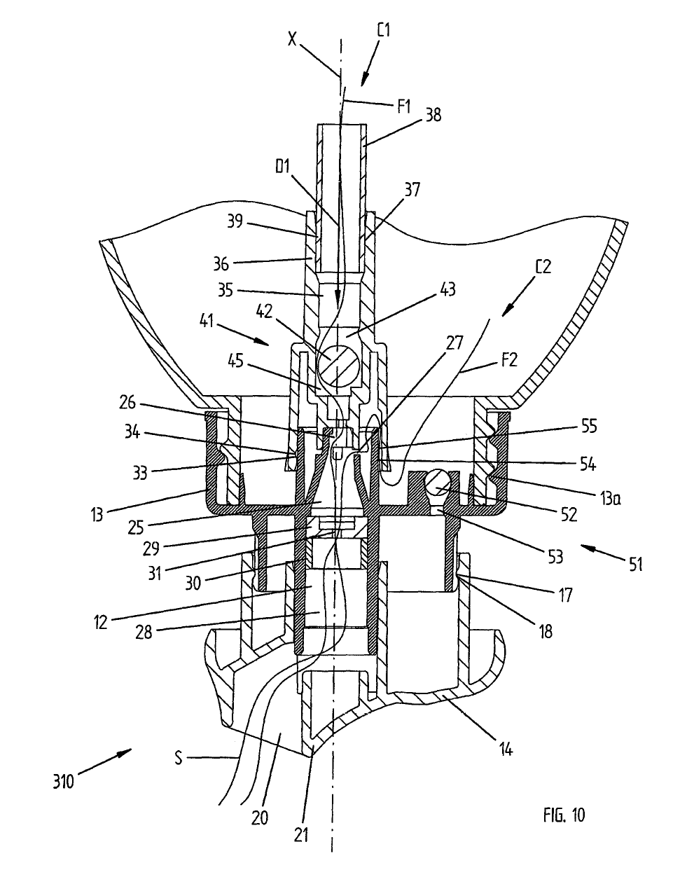

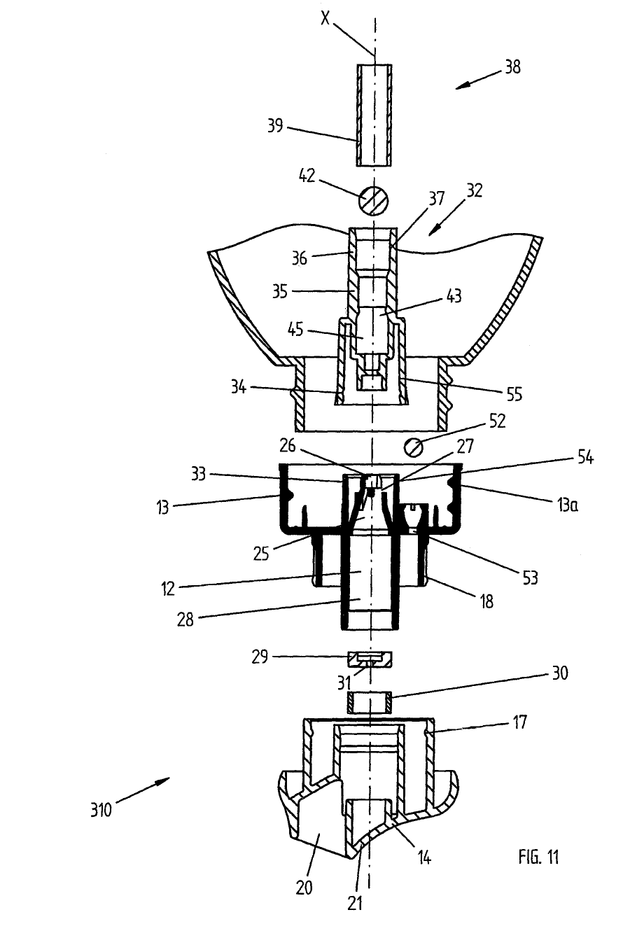

It should be noted that in the first embodiment illustrated in Figures from 1 to 4, as well as in the embodiment illustrated in FIGS. 8 and 9, the operation of the dispensing system takes place with the container C in a substantially upright position, meaning in a position with the dispensing device situated in the upper part of the container C. Figures from 5 to 7 and FIGS. 10 and 11, instead, show variant embodiments of the device of the invention in which the dispensing system works with the container C in overturned position, meaning in a position with the dispensing device situated in the lower part of the container C.

It is evident that the dispensing system can operate indifferently in the upright and in the overturned position. In the two cases the same delivery ducts C1, C2 are intended to have opposite functions, meaning that the air delivery duct will serve as fluid delivery duct and the fluid delivery duct will serve as air delivery duct, with no need to substantially change the operation of the system of the invention.

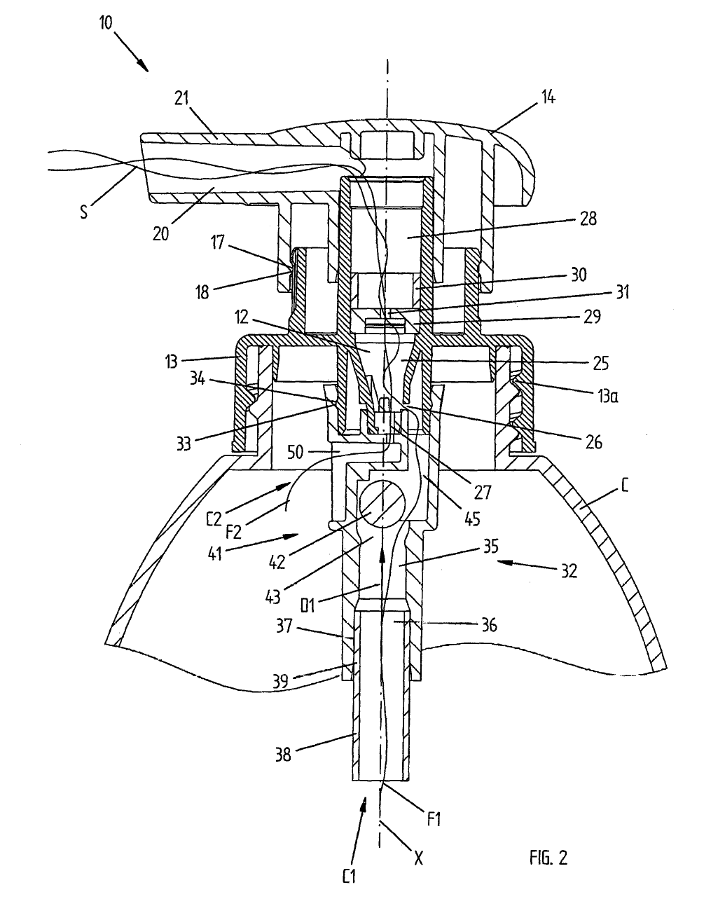

With reference to the embodiment shown in FIGS. 2, 3 and 4, the dispensing device of the invention 10 comprises a first body or supporting structure 13, provided with coupling means 13a for coupling with the container C. Said coupling means 13a preferably comprise a threaded portion suited to be engaged with a corresponding threaded portion that is present on the neck of the container C.

In variant embodiments of the invention, said coupling means may be of a different type, for example they can be of the type with snap coupling.

On top of the first body 13 there is a closing element 14 preferably ending with the spout 21 where the outlet duct 20 for the foam S is provided.

According to the example of embodiment shown in the figure, the closing element 14 is connected to the first body 13 through a snap connection obtained by means of an annular projection 17 belonging to the closing element 14 and housed in a corresponding annular cavity 18 belonging to said first body 13.

In a variant embodiment of the invention, the first body 13 and the closing element 14 can be connected through different connection means or made in a single piece, for example through a thermoplastic moulding process.

The fluid mixing chamber 12 is defined in the centre area of the first body 13. The mixing chamber 12 comprises a first mixing area 25 suited to receive the first fluid F1 through a first inlet 26 and the second fluid F2 through a second inlet 27.

The first mixing area 25 preferably has the shape of a truncated cone on whose bottom walls said inlets 26, 27 for the fluids F1, F2 to be mixed are obtained.

The mixing chamber 12 then comprises a second mixing area 28 communicating with the first mixing area 25. The second mixing area 28 has a preferably cylindrical shape and houses a diffuser element 29 and a filtering element 30. The diffuser element 29 comprises at its centre a diffuser hole 31 suited to receive the mixture from the first mixing area 25 and to convey it towards the filtering element 30.

According to the embodiment being described, there is just one diffuser hole 31 in a preferably central position with respect to the diffuser element 29. In other variant embodiments, however, the diffuser element can be provided with one or more diffuser holes with different shape and position. Said concept can be extended to all the embodiments described with reference to the present invention.

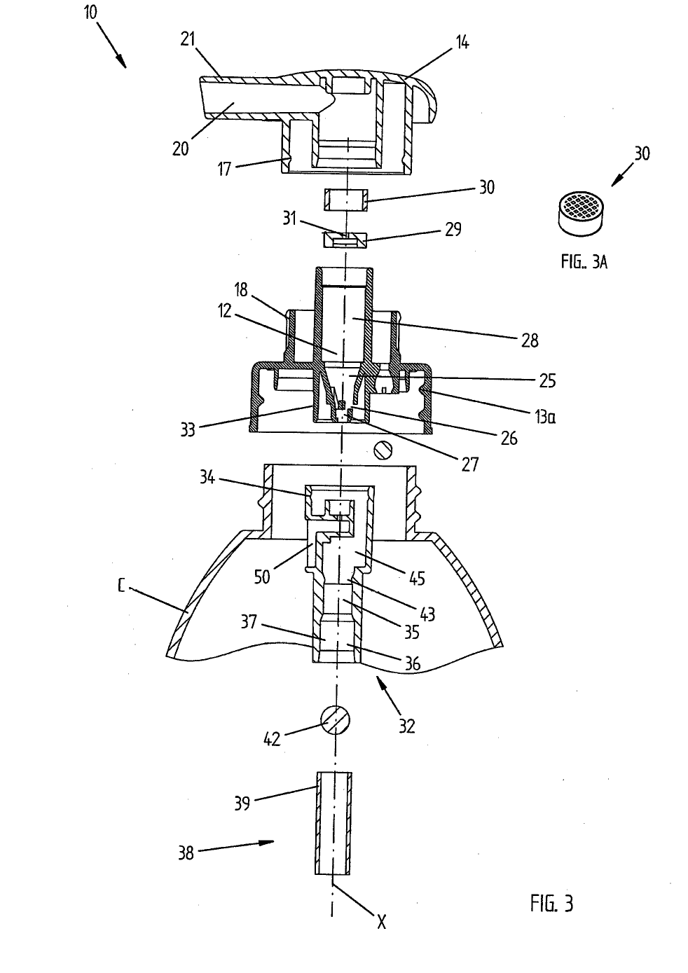

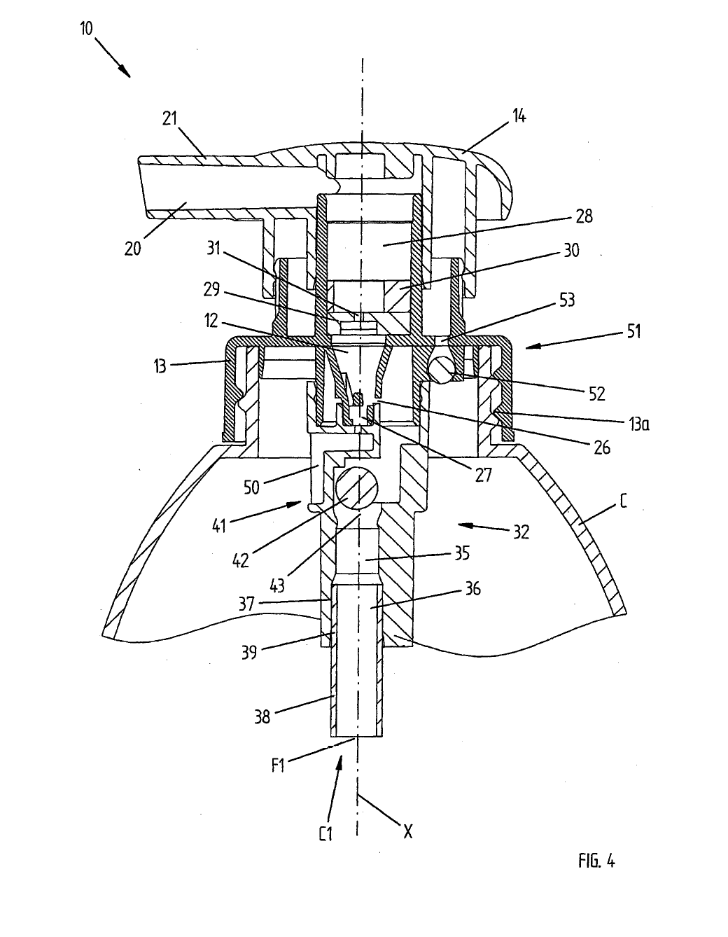

The filtering element 30, visible in the detail shown in FIG. 3A, has a substantially cylindrical shape and has a centre area provided with suitable micro holes that allow the formation of the foam S comprising micro air bubbles F2 mixed with the fluid F1, also depending on the viscosity characteristics of the fluid F1.

The first body 13 is associated with a second body 32 suited to define at least part of the delivery ducts C1, C2 suited to convey the two fluids F1 and F2 towards the mixing chamber 12.

According to the example of embodiment shown in the figure, the second body 32 is connected to the first body 13 through a snap connection obtained by means of an annular projection 33 belonging to the first body 13 and housed in a corresponding annular cavity 34 belonging to the second body 32.

In a variant embodiment of the invention the first body 13 and the second body 32 can be connected through equivalent connection means, however suited to allow them to be mutually engaged and disengaged.

The first delivery duct C1 of the first fluid F1, that is, the duct C1 that conveys the liquid drawn from the bottom of the container C, preferably comprises a first cylindrical portion 35 of the second body 32 that substantially develops along a main axis X. At least one section 36 of said first cylindrical portion 35 defines a housing seat 37 for a thin tube 38 suited to draw the first fluid F1 from a position near the bottom of the container C, as can be seen in greater detail in FIG. 1. The upper end portion 39 of the thin tube 38 is therefore accommodated inside said housing seat 37.

Preferably, the end portion 39 of the thin tube 38 is engaged in said housing seat 37 through mechanical interference.

Also the end portion 39 of the thin tube substantially develops along said main axis X. The first delivery duct C1 also comprises a second portion 45 for conveying the fluid from the first cylindrical portion 35 until it comes in proximity to the first inlet 26 of the mixing chamber 12.

Inside the first delivery duct C1, and preferably at the level of the first cylindrical portion 35, there are valve means 41 suited to allow the first fluid F1 to flow towards the mixing chamber 12 and suited to block its flow in the opposite direction, thus making it possible to maintain the fluid F1 inside the thin tube 38. The valve means 41 preferably comprise a ball 42 suited to be arranged in an open and/or closed position with respect to a circular opening 43 in said first cylindrical portion 35.

The second delivery duct C2 of the second fluid F2, that is, air, preferably comprises a shaped portion 50 of the second body 32 suited to convey the air present in the upper portion of the container C centrally towards the second inlet 27 of the mixing chamber 12.

In variant embodiments of the invention, the second delivery duct C2 of the second fluid F2, that is, air, may comprise several shaped portions arranged circumferentially on the second body 32 and suited to convey the air present in the upper portion of the container C centrally towards the second inlet 27 of the mixing chamber 12.

During operation, when the container C is pressed, the first fluid F1 and the second fluid F2 are subjected to pressure and conveyed towards the mixing chamber 12 through the respective delivery ducts C1, C2.

When the container C is pressed, the first fluid F1 is drawn by the thin tube 38 and directed along the first delivery duct C1 so that it reaches the mixing chamber 12.

In particular, the first fluid F1 is conveyed and thrust inside the end portion 39 of the thin tube 38 towards the mixing chamber 12 substantially along an advance direction D1. Said advance direction D1 is substantially parallel to the main axis X.

At the same time, the air F2 is directed along the second delivery duct C2 so that it reaches the mixing chamber 12, too. The foam S, which is successively dispensed towards the outside through the spout 21, is formed in the mixing chamber 12, in particular in the filtering element 30.

When the container C is released, the first fluid F1 is sucked back along the thin tube 38 (vacuum effect). The valve means 41, however, intervene with the ball 42 that closes the circular opening 43. Consequently, the first fluid F1 is not completely sucked back into the container C but remains inside the thin tube 38. Said fluid F1 inside the thin tube 38 will therefore be immediately ready for the successive dispensing operation to be performed by the user, which avoids the need for the container C to be pressed more than once in order to draw the first fluid F1 from the bottom of the container C before the foam S is dispensed.

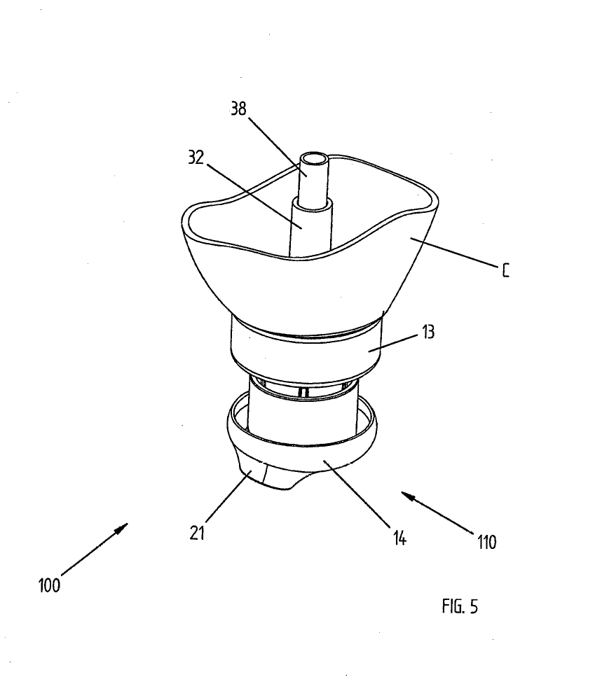

The dispensing device 10, as shown in FIG. 4, is furthermore provided with second valve means 51 suited to recover the air that operate while the container C is being released. Said valve means 51 make it possible to recover and restore the air portion that was ejected from the inside of the container C during the dispensing operation. Said valve means 51 comprise a ball 52 housed in a chamber provided with a hole 53 that is in communication with the outside. When the foam S is dispensed, the ball 52 closes the communication hole 53 while when the container C is released the ball 52 clears the communication hole 53, allowing the air to be sucked and to return inside the container C.

According to the present invention, the advance direction D1 of the first fluid F1 inside the end portion 39 of the thin tube 38, substantially parallel to the main axis X, intersects the mixing chamber 12. In other words, the main axis X, around which the housing seat 37 of the thin tube 38 develops, intersects the mixing chamber 12.

The end portion 39 of the thin tube 38, the housing seat 37 of the thin tube 38 and the mixing chamber 12 are therefore substantially aligned and coaxial with respect to the main axis X. Furthermore, the housing seat 37 of the thin tube 38 is defined centrally with respect to the second body 32.

Advantageously, the mixing chamber 12 is reached and filled by the fluids F1, F2 in a uniform manner, and not in a dishomogeneous manner, as is the case with the devices of the known type.

This makes it possible to improve the mixing of the two fluids F1, F2 inside the mixing chamber 12.

Furthermore, the special geometric configuration makes it possible to reduce the flow resistance of the fluids F1, F2 to a minimum while the container C is pressed.

Still advantageously, the central position of the housing seat 37 allows the thin tube 38 to be comfortably assembled on the second body 32. In fact, it is sufficient to centre the end portion 39 of the thin tube 38 with respect to the second body 32, with no need to worry about the rotation of the second body 32. This speeds up the assembly steps of the thin tube 38, in the case of both manual and automatic assembly.

A variant embodiment of the dispensing system 100 of the invention is described with reference to Figures from 5 to 7, and it mainly differs from the first embodiment described above owing to the fact that it works with the container C in overturned position.

In this case, as already explained, the first duct C1 serves as delivery duct for the air F1 and the second duct C2 serves as delivery duct for the fluid F2.

The container C will be filled with the fluid F2 until a suitable level is reached, while the remaining space above said fluid F1 will contain air that is suited to constitute the other fluid F2 making up the foam S to be obtained.

The dispensing device 110 of the invention comprises a first body or supporting structure 13, provided with coupling means 13a for coupling with the container C. Said coupling means 13a preferably comprise a threaded portion suited to be engaged with a corresponding threaded portion present on the neck of the container C.

In variant embodiments, said coupling means may be of a different type, for example snap coupling means.

On the underside of the first body 13 there is a closing element 14 preferably ending with a spout 21, where the outlet duct 20 for the foam S is provided.

According to the example of embodiment shown in the figure, the closing element 14 is connected to the first body 13 through a snap connection obtained by means of an annular projection 17 belonging to the closing element 14 and housed in a corresponding annular cavity 18 belonging to said first body 13.

In a variant embodiment of the invention the first body 13 and the closing element 14 may be connected through different connection means or produced in a single piece, for example through a thermoplastic moulding process.

The fluid mixing chamber 12 is defined in the centre area of the first body 13. The mixing chamber 12 comprises a mixing area 25 suited to receive the two fluids F1 (air) and F2 (liquid) from the respective delivery ducts C1 and C2 through a diffuser hole 31.

Preferably, the mixing area 25 has substantially the shape of a cylinder on whose bottom wall there is said diffuser hole 31.

The inside of the mixing area 25 houses a filtering element 30. The diffuser hole 31 conveys the mixture of the two fluids F1 and F2 towards the filtering element 30. The filtering element 30, substantially the same as that shown in FIG. 3A, has a substantially cylindrical shape and has a centre area provided with suitable micro holes that allow the formation of the foam S comprising micro air bubbles F1 mixed with the fluid F2, also depending on the viscosity characteristics of the fluid F2.

The first body 13 is associated with a second body 32 suited to define at least part of the delivery ducts C1, C2 suited to convey the two fluids F1 and F2 towards the mixing chamber 12, and in particular towards the diffuser hole 31.

According to the example of embodiment shown in the figure, the second body 32 is connected to the first body 13 through a snap connection obtained by means of an annular projection 33 belonging to the first body 13 and housed in a corresponding annular cavity 34 belonging to said second body 32.

According to a variant embodiment of the invention, the first body 13 and the second body 32 can be connected using different equivalent connection means, however suited to allow them to be mutually engaged and disengaged.

The first delivery duct C1 of the first fluid F1, that is, the duct C1 that conveys the air from the container C, preferably comprises a first cylindrical portion 35 of the second body 32 that develops substantially along a main axis X. At least one section 36 of said first cylindrical portion 35 defines a housing seat 37 for a thin tube 38 suited to convey the first fluid F1. The lower end portion 39 of the thin tube 38 is thus accommodated inside said housing seat 37.

Preferably, the end portion 39 of the thin tube 38 is engaged in said housing seat 37 through mechanical interference.

Also the end portion 39 of the thin tube develops substantially along said main axis X. The first delivery duct C1 also comprises a second portion 45 suited to convey the fluid F1 from the first cylindrical portion 35 until it comes in proximity to the diffuser hole 31.

More particularly, a portion of said first delivery duct C1 is defined by two facing surfaces 54, 55 respectively belonging to said first body 13 and to said second body 32. At least one space suited to allow the passage of the fluid F1 (air) is advantageously defined between the two facing surfaces 54, 55.

Preferably, more spaces suited to allow the passage of the fluid F1 (air) are preferably defined between the two facing surfaces 54, 55, said spaces being preferably arranged so that they are equally spaced angularly for more homogeneous delivery of the fluid F1 (air) towards the diffuser hole 31.

Inside the first delivery duct C1, and preferably at the level of the first cylindrical portion 35, there are valve means 41 suited to allow the first fluid F1 (air) to flow towards the mixing chamber 12 and suited to block the possible flow of the second fluid F2 coming from the diffuser hole 31 in the opposite direction inside the thin tube 38 during the release of the container C.

The valve means 41 preferably comprise a ball 42 suited to be arranged in an open and/or closed position with respect to a circular opening 43 in said first cylindrical portion 35.

The second delivery duct C2 of the second fluid F2, that is, the liquid, preferably comprises a shaped portion 50 of the second body 32 suited to convey the liquid from the lower portion of the container C centrally towards the diffuser hole 31.

In variant embodiments, the second delivery duct C2 of the second fluid F2, that is, the liquid, may comprise several shaped portions arranged circumferentially on the second body 32 and suited to convey the liquid from the lower portion of the container C centrally towards the diffuser hole 31.

During operation, when the container C is pressed, the first fluid F1 and the second fluid F2 are subjected to pressure and conveyed towards the mixing chamber 12 through the respective delivery ducts C1, C2.

When the container C is pressed, the first fluid F1 (airs) enters the thin tube 38 and is directed along the first delivery duct C1 so that it reaches the mixing chamber 12.

In particular, the first fluid F1 is conveyed inside the end portion 39 of the thin tube 38 towards the mixing chamber 12 substantially along an advance direction D1. Said advance direction D1 is substantially parallel to the main axis X.

At the same time, the liquid F2 is directed along the second delivery duct C2 so that it reaches the mixing chamber 12, too. The foam S, which is successively dispensed towards the outside through the spout 21, is produced in the mixing chamber 12, in particular in the filtering element 30.

The dispensing device 110, analogously to what happens for the first embodiment, is furthermore provided with second valve means 51 that are suited to recover the air and are activated while the container C is being released. Said valve means 51 make it possible to recover and restore the portion of air that was ejected from the inside of the container C during the dispensing operation. Said valve means 51 comprise a ball 52 housed in a chamber provided with a hole 53 that communicates with the outside.

When the foam S is dispensed, the ball 52 closes the communication hole 53 while when the container C is released the ball 52 clears the communication hole 53 allowing the air to be sucked and to return inside the container C.

According to the present invention, the advance direction D1 of the first fluid F1 inside the end portion 39 of the thin tube 38, substantially parallel to the main axis X, intersects the mixing chamber 12. In other words, the main axis X, around which the housing seat 37 of the thin tube 38 develops, intersects the mixing chamber 12.

The end portion 39 of the thin tube 38, the housing seat 37 of the thin tube 38 and the mixing chamber 12 are therefore substantially aligned and coaxial with respect to the main axis X. Furthermore, the housing seat 37 of the thin tube 38 is defined centrally with respect to the second body 32.

Advantageously, the mixing chamber 12 is reached and filled by the fluids F1, F2 in a uniform manner and not in a dishomogeneous manner, as is the case with the devices of the known type.

This makes it possible to improve the mixing of the two fluids F1, F2 inside the mixing chamber 12.

Furthermore, the special geometric configuration makes it possible to reduce the flow resistance of the fluids F1, F2 to a minimum while the container C is pressed.

Still advantageously, the central position of the housing seat 37 allows the thin tube 38 to be comfortably assembled on the second body 32. In fact, it is sufficient to centre the end portion 39 of the thin tube 38 with respect to the second body 32, with no need to worry about the rotation of the second body 32. This speeds up the assembly steps of the thin tube 38, in the case of both manual and automatic assembly.

A variant embodiment of the dispensing system of the invention, which works with the container C arranged in the upright position, is described with reference to FIGS. 8 and 9.

The container C, not visible in the figure, is filled with a first fluid F1 up to a suitable level, while the remaining space above said fluid F1 will contain air, suited to constitute the second fluid F2 making up the foam S to be obtained, analogously to that which is shown in FIG. 1.

The dispensing device of the invention, indicated as a whole by 210, is applied to the neck of said container C.

The dispensing device 210 that is the subject of the invention comprises a first body or supporting structure 13, provided with coupling means 13a for coupling to the container C. Said coupling means 13a preferably comprise a threaded portion suited to be engaged with a corresponding threaded portion present on the neck of the container C.

In variant embodiments, said coupling means may be of a different type, for example snap coupling means.

On top of the first body 13 there is a closing element 14 preferably ending with the spout 21, where the outlet duct 20 for the foam S is provided.

According to the example of embodiment shown in the figure, the closing element 14 is connected to the first body 13 through a snap connection obtained by means of an annular projection 17 belonging to the closing element 14 and housed in a corresponding annular cavity 18 belonging to said first body 13.

According to a variant embodiment of the invention, the first body 13 and the closing element 14 can be connected through different connection means or obtained in a single piece, for example through a thermoplastic moulding process.

The fluid mixing chamber 12 is defined in the centre area of the first body 13. The mixing chamber 12 comprises a mixing area 25 suited to receive the two fluids F1 (liquid) and F2 (air) from the respective delivery ducts C1 and C2.

The mixing area 25 has a substantially cylindrical shape and houses a diffuser element 29 and a filtering element 30.

In a variant embodiment, shown in FIG. 9A, the mixing area 25 houses only the filtering element 30, while the diffuser element 29 can be omitted.

The diffuser element 29 comprises at its centre a first diffuser hole 31 suited to receive the mixture from a second diffuser hole 131 at the base of the mixing area 25 and to convey said mixture towards the filtering element 30.

The filtering element 30, substantially the same as that shown in FIG. 3A, has a substantially cylindrical shape and has a centre area provided with suitable micro holes that allow the formation of the foam S comprising micro air bubbles F2 mixed with the fluid F1, also depending on the viscosity characteristics of the fluid F1.

The first body 13 is associated with a second body 32 suited to define at least part of the delivery ducts C1, C2 suited to convey the two fluids F1 and F2 towards the mixing chamber 12, and in particular towards the two diffuser holes 31, 131. According to the example of embodiment shown in the figure, the second body 32 is connected to the first body 13 through a snap connection obtained by means of an annular projection 33 belonging to the first body 13 and housed in a corresponding annular cavity 34 belonging to said second body 13.

In a variant embodiment of the invention, the first body 13 and the second body 32 can be connected through equivalent connection means, however suited to allow them to be mutually engaged and disengaged.

The first delivery duct C1 of the first fluid F1, that is, the duct C1 that conveys the fluid drawn from the bottom of the container C, preferably comprises a first cylindrical portion 35 of the second body 32 that substantially develops along a main axis X. At least one section 36 of said first cylindrical portion 35 defines a housing seat 37 for a thin tube 38 suited to draw the first fluid F1. The lower end portion 39 of the thin tube 38 is therefore accommodated inside said housing seat 37.

The end portion 39 of the thin tube 38 is preferably engaged in said housing seat 37 through mechanical interference.

Also the end portion 39 of the thin tube develops substantially along said main axis X. The first delivery duct C1 also comprises a second portion 45 suited to convey the fluid from the first cylindrical portion 35 until it comes in proximity to the diffuser hole 131.

Inside the first delivery duct C1, and preferably at the level of the first cylindrical portion 35, there are valve means 41 suited to allow the first fluid F1 to flow towards the mixing chamber 12 and suited to block its flow in the opposite direction, thus making it possible to keep the fluid F1 inside the thin tube 38. The valve means 41 preferably comprise a ball 42 suited to be arranged in an open and/or closed position with respect to a circular opening 43 present in said first cylindrical portion 35.

The second delivery duct C2 of the second fluid F2, that is, air, preferably comprises two delivery portions defined by facing surfaces 54a, 55a, 54b, 55b respectively belonging to said first body 13 and to said second body 32.

The two delivery portions of the second delivery duct C2 allow the second fluid F2 to flow from the inside of the container C to the second diffuser hole 131. The first delivery portion communicates with the inside of the container C and the second delivery portion, positioned coaxially inside the first one, connects the first delivery portion to the second diffuser hole 131.

A space suited to allow the passage of the fluid F2 is advantageously defined between the facing surfaces 54a, 55a, 54b, 55b.

Preferably, more spaces suited to allow the passage of the fluid F2 (air) are defined between the two facing surfaces 54a, 55a, 54b, 55b, said spaces being preferably arranged so that they are equally spaced angularly for more homogeneous delivery of the fluid F2 towards the second diffuser hole 131.

During operation, when the container C is pressed by the user the first fluid F1 is drawn by the thin tube 38 and directed along the first delivery duct C1 so that it reaches the mixing chamber 12.

In particular, the first fluid F1 is conveyed and thrust into the end portion 39 of the thin tube 38 towards the mixing chamber 12 substantially along an advance direction D1. Said advance direction D1 is substantially parallel to the main axis X.

At the same time the air F2 is directed along the second delivery duct C2 so that it reaches the mixing chamber 12, too.

The foam S that is then dispensed towards the outside through the spout 21 is formed in the mixing chamber 12, in particular in the filtering element 30.

When the container C is released, the first fluid F1 is sucked back along the thin tube 38 (vacuum effect). The valve means 41, however, intervene through the ball 42 that comes to be positioned on the circular opening 43 so as to close it. Consequently, the first fluid F1 is not completely sucked into the container C but is maintained within the thin tube 38.

Said fluid F1 inside the thin tube 38 will therefore be immediately ready for the successive dispensing step performed by the user, who will not need to press the container several times to draw the first fluid F1 from the bottom of the container C before the foam S is dispensed.

The dispensing device 210, as in the previous embodiments, is also provided with second valve means 51 suited to recover the air and activated while the container C is being released. Said valve means 51 make it possible to recover and restore the portion of air that was ejected from the inside of the container C during the dispensing operation. Said valve means 51 comprise a ball 52 housed in a chamber provided with a hole 53 that communicates with the outside. When the foam S is dispensed the ball 52 closes the communication hole 53 while when the container C is released the ball 52 clears the communication hole 53, allowing the air to be sucked and to return into the container C.

According to the present invention, the advance direction D1 of the first fluid F1 inside the end portion 39 of the thin tube 38, substantially parallel to the main axis X, intersects the mixing chamber 12. In other words, the main axis X, around which the housing seat 37 of the thin tube 38 develops, intersects the mixing chamber 12.

The end portion 39 of the thin tube 38, the housing seat 37 of the thin tube 38 and the mixing chamber 12 are therefore substantially aligned and coaxial with respect to the main axis X. Furthermore, the housing seat 37 of the thin tube 38 is defined centrally with respect to the second body 32.

Advantageously, the mixing chamber 12 is reached and filled by the fluids F1, F2 in a uniform manner, and not in a dishomogeneous manner, as is the case with the devices of the known type.

This makes it possible to improve the mixing of the two fluids F1, F2 inside the mixing chamber 12.

Furthermore, the particular geometric configuration makes it possible to reduce the flow resistance of the fluids F1, F2 to a minimum while the container C is being pressed.

Still advantageously, the central position of the housing seat 37 allows the thin tube 38 to be comfortably assembled on the second body 32. In fact, it will be sufficient to centre the end portion 39 of the thin tube 38 with respect to the second body 32, with no need to worry about the rotation of the second body 32 itself. This speeds up the assembly steps of the thin tube 38, in case of both manual and automatic assembly.

Furthermore, the presence of a delivery duct for the fluid F2, in particular for the air, defined by facing surfaces of the first and the second body, advantageously makes it possible to adjust cross section through which the fluid F2 flows.

A variant embodiment of the dispensing system of the invention, according to which operation takes place with the container C in overturned position, is described with reference to FIGS. 10 and 11, analogously to that which happens for the embodiment illustrated in Figures from 5 to 7.

In this case, as already explained above, the first duct C1 serves as delivery duct for the air F1 and the second duct C2 serves as delivery duct for the fluid F2.

The dispensing device 310 of the invention comprises a first body 13, provided with coupling means 13a for coupling to the container C. Said coupling means 13a preferably comprise a threaded portion suited to be engaged with a corresponding threaded portion present on the neck of the container C.

In variant embodiments, said coupling means may be of a different type, for example snap coupling means.

On the underside of the first body 13 there is a closing element 14 preferably ending with a spout 21 where the outlet duct 20 for the foam S is provided. According to the example of embodiment shown in the figure, the closing element 14 is connected to the first body 13 through a snap connection obtained by means of an annular projection 17 belonging to the closing element 14 and housed in a corresponding annular cavity 18 belonging to said first body 13.

According to a variant embodiment of the invention, the first body 13 and the closing element 14 may be connected through different connection means or obtained in a single piece, for example through a thermoplastic moulding process.

The fluid mixing chamber 12 is defined in the central area of the first body 13. The mixing chamber 12 comprises a first mixing area 25 suited to receive the first fluid F1 through a first inlet 26 and the second fluid F2 through a second inlet 27.

The first mixing area 25 preferably has the shape of a truncated cone on whose bottom walls said inlets 26, 27 for the fluids F1, F2 to be mixed are obtained.

The mixing chamber 12 also comprises a second mixing area 28 communicating with the first mixing area 25. The second mixing area 28 has a substantially cylindrical shape and houses a diffuser element 29 and a filtering element 30.

The diffuser element 29 comprises at its centre a diffuser hole 31 suited to receive the mixture from the first mixing area 25 and to convey it towards the filtering element 30.

The filtering element 30, substantially the same as the one shown in FIG. 3A, has a substantially cylindrical shape and has a centre area provided with suitable micro holes that allow the formation of the foam S comprising micro air bubbles F1 mixed with the fluid F2, also depending on the viscosity characteristics of the fluid F2.

The first body 13 is associated with a second body 32 suited to define at least part of the delivery ducts C1, C2 suited to convey the two fluids F1 and F2 towards the mixing chamber 12.

According to the example of embodiment shown in the figure, the second body 32 is connected to the first body 13 through a snap connection obtained by means of an annular projection 33 belonging to the first body 13 and housed in a corresponding annular cavity 34 belonging to said second body 32.

In variant embodiment of the invention, the first body 13 and the second body 32 can be connected through equivalent connection means, however suited to allow them to be mutually engaged and disengaged.

The first delivery duct C1 of the first fluid F1, that is, air, preferably comprises a first cylindrical portion 35 of the second body 32 that substantially develops along a main axis X. At least one section 36 of said first cylindrical portion 35 defines a housing seat 37 for a thin tube 38 suited to draw the first fluid F1. The lower end portion 39 of the thin tube 38 is therefore accommodated inside said housing seat 37.

Preferably, the end portion 39 of the thin tube 38 is engaged in said housing seat 37 through mechanical interference.

Also the end portion 39 of the thin tube develops substantially along said main axis X. The first delivery duct C1 also comprises a second portion 45 suited to convey the fluid from the first cylindrical portion 35 until it comes in proximity to the first inlet 26 of the first mixing area 25.

Inside the first delivery duct C1, and preferably at the level of the first cylindrical portion 35, there are valve means 41 suited to allow the first fluid F1 (air) to flow towards the mixing chamber 12 and suited to block any flow of the second fluid F2 coming from the diffuser hole 31 in the opposite direction inside the thin tube 38 during the release step.

The valve means 41 preferably comprise a ball 42 suited to be arranged in an open and/or closed position with respect to a circular opening 43 present in said first cylindrical portion 35.

The second delivery duct C2 of the second fluid F2 preferably comprises a portion defined by facing surfaces 54, 55 respectively belonging to said first body 13 and to said second body 32. A space suited to allow the passage of the fluid F2 is advantageously defined between the two facing surfaces 54, 55.

Said portion of the second delivery duct C2 allows the second fluid F2 to flow from the inside of the container C to the second inlet 27 of the first mixing area 25.

During operation, when the container C is pressed, the first fluid F1 and the second fluid F2 are subjected to pressure and conveyed towards the first mixing area 25 through the respective delivery ducts C1, C2.

When the container C is pressed, the first fluid F1 (air) gets into the thin tube 38 and is directed along the first delivery duct C1 so that it reaches the first mixing area 25.

In particular, the first fluid F1 is conveyed and thrust inside the end portion 39 of the thin tube 38 towards the first mixing area 25 substantially along an advance direction D1. Said advance direction D1 is substantially parallel to the main axis X.

At the same time, the liquid F2 is directed along the second delivery duct C2 so that it reaches the first mixing area 25, too. The foam S, which is successively dispensed towards the outside through the spout 21, is formed in the mixing chamber 12, in particular in the filtering element 30.

The dispensing device 310, analogously to the embodiments described above, is furthermore provided with second valve means 51 suited to recover the air and activated while the container C is being released. Said valve means 51 make it possible to recover the air portion that was ejected from the inside of the container C during the dispensing operation. Said valve means 51 comprise a ball 52 housed in a chamber provided with a hole 53 that communicates with the outside. When the foam S is dispensed, the ball 52 closes the communication hole 53 while when the container C is released the ball 52 clears the communication hole 53, allowing the air to be sucked and to return inside the container C.

According to the present invention, the advance direction D1 of the first fluid F1 inside the end portion 39 of the thin tube 38, substantially parallel to the main axis X, intersects the mixing chamber 12. In other words, the main axis X, around which the housing seat 37 of the thin tube 38 develops, intersects the mixing chamber 12.

The end portion 39 of the thin tube 38, the housing seat 37 of the thin tube 38 and the mixing chamber 12 are therefore substantially aligned and coaxial with respect to the main axis X. Furthermore, the housing seat 37 of the thin tube 38 is defined centrally with respect to the second body 32.

Advantageously, the mixing chamber 12 is reached and filled by the fluids F1, F2 in a uniform manner and not in a dishomogeneous manner, as is the case with the devices of the known type.

This makes it possible to improve the mixing of the two fluids F1, F2 inside the mixing chamber 12.

Furthermore, the special geometric configuration makes it possible to reduce the flow resistance of the fluids F1, F2 to a minimum while the container C is pressed.

Still advantageously, the central position of the housing seat 37 allows the thin tube 38 to be comfortably assembled on the second body 32. In fact, it is sufficient to centre the end portion 39 of the thin tube 38 with respect to the second body 32, with no need to worry about the rotation of the second body 32. This speeds up the assembly steps of the thin tube 38, in the case of both manual and automatic assembly.

Furthermore, the presence of a fluid delivery duct, in particular for the liquid F2, defined by facing surfaces of the first and second body, advantageously makes it possible to adjust the cross section through which the fluid F2 flows.

According to the present invention, the presence of different properly interconnected elements makes it possible to produce the same as modules and thus to reduce their productions costs.

In particular, the presence of a first and a second body that can be easily interconnected, as well as the possibility to connect the closing element and the thin tube to them, makes it possible to obtain elements that can be used in different manners and according to the desired configuration of the dispensing system.

Thus, for example, a comparison between FIGS. 2 and 3 and FIGS. 10 and 11 clearly shows that, maintaining the same first body 13 and the same thin tube 38, it is possible to obtain a dispensing system that works either in the upright or in the overturned position by using a different second body 32 and preferably but not necessarily a different closing element 14. In other words, it is possible to transform a dispensing device that works in the upright position into a dispensing system that works in the overturned position by simply changing the second body 32, and if necessary the closing element 14. Vice versa, it is possible to transform a dispensing device that works in the overturned position into a dispensing system that works in the upright position by simply changing the second body 32, and if necessary the closing element 14.

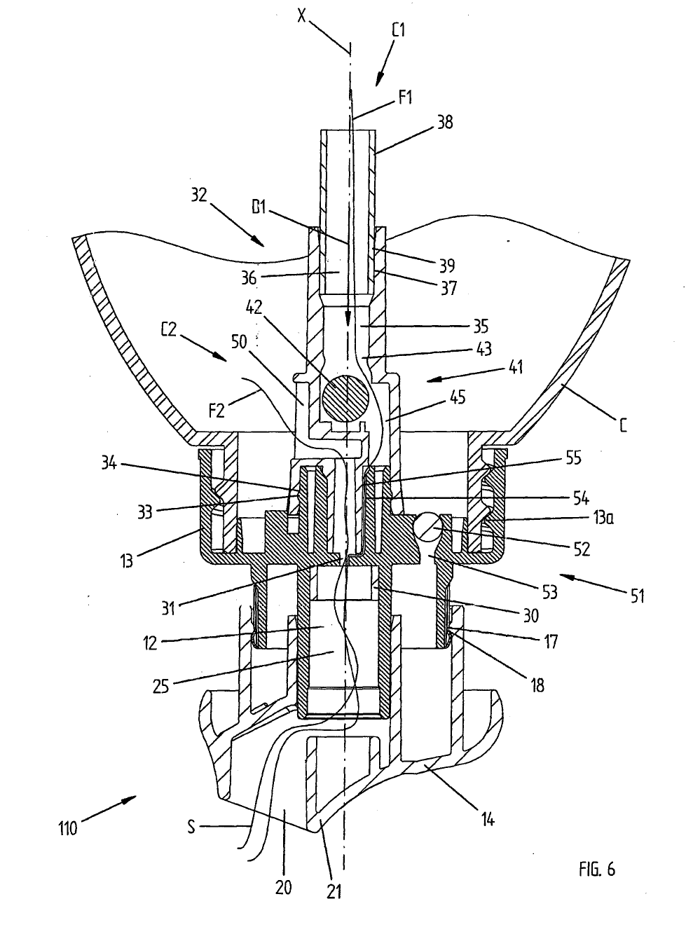

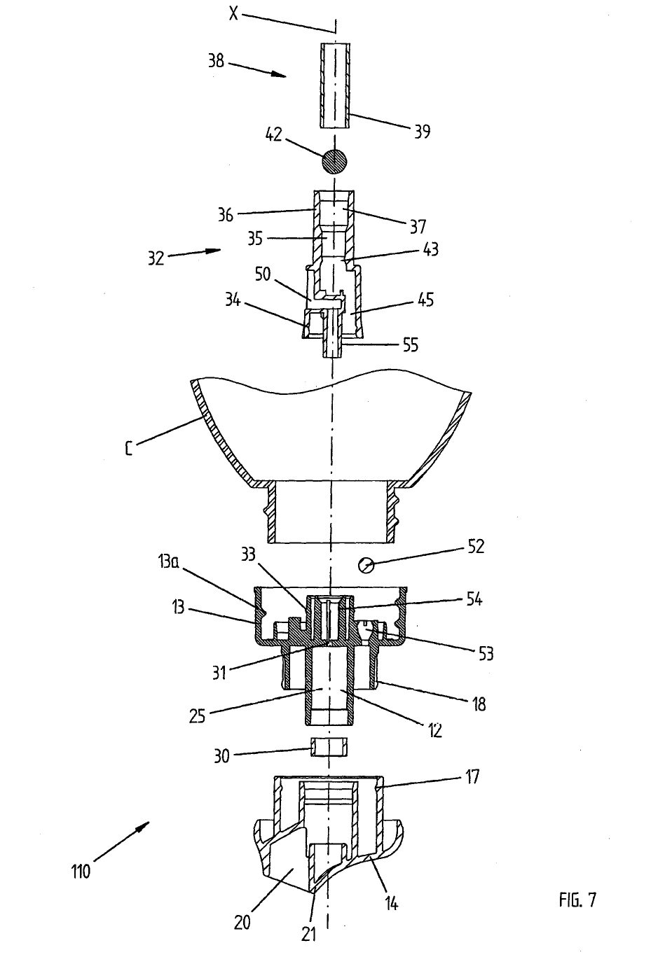

Analogously, a comparison between FIGS. 6 and 7 and FIGS. 8 and 9 clearly shows that, maintaining the same first body 13 and the same thin tube 38, it is possible to obtain a dispensing system that works either in the overturned position or in the upright position by using a different second body 32, and preferably but not necessarily a different closing element 14. In other words, it is possible to transform a dispensing device that works in the overturned position into a dispensing system that works in the upright position by simply changing the second body 32, and if necessary the closing element 14. Vice versa, it is possible to transform a dispensing device that works in the upright position into a dispensing system that works in the overturned position by simply changing the second body 32, and if necessary the closing element 14.

In this way, advantageously, the dispensing device of the invention makes it possible to reduce production costs compared to the devices of the known type. Furthermore, the presence of several elements that can be interconnected and replaced quickly makes it possible to use different geometric configurations for those elements, which allow the flows of the two fluids inside the respective ducts to be modified. In this way, the percentage of the two fluids inside the same mixture can be regulated as desired, which makes it possible to obtain thicker or thinner foams depending on the expected use.

This can be advantageously and comfortably achieved by replacing either the first body 13 or the second body 32, preferably the second body 32, while the other can remain the same. By replacing just one element, therefore, it is possible to modify the density of the foam to be obtained as desired.

This also makes it possible to reduce the number of elements to be produced for the different types of foam to be obtained, thus reducing the overall production costs compared to the devices of the known type.

The above applies to all the embodiments of the invention described above.

In the embodiments of the present invention previously described, the shape of the thin tube and of its housing seat in the second body is cylindrical, wherein said cylindrical shape extends along said main axis X.

However, in different construction variants said parts may have a different shape, provided that it is suited to define an advance direction of the fluid and that it ensures the characteristics and the advantages described in the present invention.

It has thus been shown that the present invention allows the set objects to be achieved. In particular, it makes it possible to provide a fluid dispensing device that allows production costs to be reduced compared to the devices of the known type.

If on the one hand the present invention has been described making reference to the specific embodiments illustrated in the figures, it should be noted on the other hand that the present invention is not limited to the specific embodiments illustrated and described herein; on the contrary, further variants of the embodiments described herein fall within the scope of the present invention which is defined in the following claims.

1. Device for dispensing a mixture, suited to be applied to a container containing a first fluid and a second fluid that are suited to be mixed in order to obtain said mixture, said device comprising:
a first body;
a second body associated with said first body;
a mixing chamber defined at least partially in said first body and/or in said second body;
a first duct suited to convey said first fluid towards said mixing chamber;
a second duct suited to convey said second fluid towards said mixing chamber;
a tube suited to define at least partially said first duct and comprising an end portion connected to said first or to said second body,
wherein said end portion of said tube is connected to said first body or to said second body in such a way as to define for said first fluid a main advance direction belonging to a longitudinal axis that intersects said mixing chamber.

2. Device according to claim 1, wherein said end portion of said tube has a substantially cylindrical shape that extends along said longitudinal axis.

3. Device according to claim 1, wherein said end portion of said tube is accommodated in a housing seat in said first body or said second body, said housing seat extending along said longitudinal axis.

4. Device according to claim 3, wherein said housing seat has a portion that is substantially cylindrical in shape.

5. Device according to claim 3, wherein said housing seat is positioned centrally with respect to said first body or said second body in which it is obtained.

6. Device according to claim 1, further comprising:
valve means for allowing the flow of said first fluid in said tube to be blocked.

7. Device according to claim 6, wherein said valve means are arranged upstream of said mixing chamber with reference to said main advance direction of said first fluid.

8. Device according to claim 1 wherein said first duct comprises at least one section for conveying said first fluid defined by at least two facing surfaces respectively belonging to said first body and to said second body.

9. Device according to claim 1 wherein said second duct comprises at least one section for conveying said second fluid defined by at least two facing surfaces respectively belonging to said first body and to said second body.

10. Device according to claim 1 further comprising:
snap connection means, between said first body and said second body, for connecting said first body and said second body.

11. Device according to claim 1 further comprising:
further valve means for restoring air inside said container once said mixture has been dispensed.

12. Device according to claim 1 wherein said first fluid comprises a liquid or cream and said second fluid comprises air.

13. Device according to claim 1 wherein said first fluid comprises air and said second fluid comprises a liquid or cream.

14. Device according to claim 1 wherein said mixture is a foam.

15. Device according to claim 1 wherein said first body is provided with means for connecting to said container.

16. System for dispensing a mixture, comprising a container suited to hold two fluids to be mixed and a dispensing device associated with said container and suited to mix said fluids and dispense said mixture, wherein said dispensing device is made according to claim 1.

17. A device for mixing a first fluid and a second fluid comprising:
a deformable container having an opening;
a first body covering the opening and having a first inlet;
a closing element covering said first body having a duct;
a second body attached to said first body;
a tube having an axis coupled to said second body, said tube conveying the first fluid from within said container towards and through said second body into said first body and through the first inlet;
a mixing area placed within said first body coaxially with the axis of said tube;
a shaped portion formed within said second body portion, said shaped portion open to a second fluid within said container and having a second inlet to said mixing area; and
a filtering element placed adjacent an end of said mixing area coaxially with the axis of said tube,
whereby when said deformable container is pressed the first fluid and the second fluid are moved substantially coaxially into and mixed within the mixing area and a foam formed passing though said filtering element and dispensed through the duct.
